(19) United States
(12) Patent Application Publication
(10) Pub. No.: US 2026/0042400 A1
(43) Pub. Date: Feb. 12, 2026

(54) STORAGE COMPARTMENT ARRANGEMENT FOR A MOTOR VEHICLE

(71) Applicant: BOS GmbH & Co. KG, Ostfildern (DE)

(72) Inventors: Mickey HANNAN, Shelby Township, MI (US); Siddhartha BABBURI, South Lyon, MI (US)

(21) Appl. No.: 18/800,533

(22) Filed: Aug. 12, 2024

(51) Int. Cl. B60R 5/02; B60N 3/00

(52) U.S. Cl. CPC B60R 5/02; B60N 3/001

(57) ABSTRACT

A storage space arrangement with a storage space floor which limits a storage space downwards along a vertical axis, with at least two side walls which project upwards from the storage space floor along the vertical axis and are opposite one another along a transverse axis, and with a rear wall which projects upwards from the storage space floor along the vertical axis and extends along the transverse axis between the side walls. A table device is provided with a tabletop fastened to the rear wall and movable relative to the rear wall between a function position and a rest position. The tabletop is oriented in a vertical position aligned with the rear wall in the rest position, and the tabletop is oriented horizontally and away from the rear wall in the function position.

The invention relates to a storage space arrangement for a motor vehicle.

Known storage space arrangements have a storage space floor, at least two side walls and one rear wall. The storage space floor limits a storage space downwards along a vertical axis. The at least two side walls project upwards from the storage space floor along the vertical axis and are opposite one another along a transverse axis. The rear wall too projects upwards from the storage space floor along the vertical axis and extends along the transverse axis between the side walls.

It is an object of the invention to provide a storage space arrangement for a motor vehicle that offers advantages over the prior art. In particular, improved ergonomics during loading and unloading of the storage space and versatility in use are to be achieved.

This object is achieved by providing a storage space arrangement having the features of independent claim 1. Advantageous embodiments are defined in the dependent claims. The wording of the claims is incorporated into the description by reference.

The storage space arrangement in accordance with the invention has a storage space floor, at least two side walls, a rear wall and a table device. The storage space floor limits a storage space downwards along a vertical axis. The at least two side walls project upwards from the storage space floor along the vertical axis and are opposite one another along a transverse axis. The rear wall projects upwards from the storage space floor along the vertical axis and extends along the transverse axis between the side walls. The table device has a tabletop which is fastened to the rear wall and is movable relative to the rear wall between a function position and a rest position. In the rest position, the tabletop is moved vertically aligned to the rear wall. In the function position, the tabletop is moved horizontally aligned away from the rear wall. During loading of the storage space, the load may initially be placed temporarily on the tabletop horizontally aligned in the function position. This applies correspondingly for unloading of the storage space. This improves the ergonomics of loading and unloading the storage space. The table device may, in the function position of the tabletop, also be used for a very wide range of other purposes, for example as a kind of workbench, camping table, desk or the like. Since the tabletop in the rest position is moved vertically aligned to the rear wall, the accessibility and usability of the storage space are not impaired. In one embodiment, the storage space is a rear trunk. In a further embodiment, the storage space is a front trunk, known as a frunk. In a preferred embodiment, the tabletop is fastened exclusively to the rear wall. As a result, the storage space floor remains free for the arrangement of loads. The tabletop is, in different embodiments, movable in different ways between the function position and the rest position. For example, the tabletop is fastened to the rear wall in translational, rotational, swivelably movable, swingably movable and/or foldably movable manner relative to the rear wall. In the rest position, the tabletop is vertically aligned, specifically parallel to the rear wall and/or to the vertical axis. In the function position, the tabletop is horizontally oriented, preferably parallel to the transverse axis and to a longitudinal axis, i.e. parallel to a horizontal plane. In the function position, the tabletop is arranged along the vertical axis above the storage space floor. Preferably, the tabletop is settable in its inclination in the function position. The tabletop may be produced from any material suitable for the present purpose, for example from a laminated material, plastic and/or aluminum. The tabletop has in different embodiments different shapes, for example a square and specifically a rectangular shape.

In one embodiment, the table device has a swing axis, about which the tabletop is swingably movable between the function position and the rest position. Preferably, the swing axis extends longitudinally along the transverse axis, specifically parallel to the transverse axis. Preferably, the swing axis is arranged in the area of an upper edge, at the top along the vertical axis, of the rear wall. The swing axis may be an axis in the geometrical sense and/or a physically existing structural element (axle). The swingable movability of the tabletop is easy to implement in terms of design. Also, the swing axis requires only a small installation space, so that the usability of the storage space is not impaired.

In a further embodiment, the table device has at least one table leg which extends longitudinally between a first leg end and a second leg end, wherein the first leg end is movably fastened to an underside of the tabletop and wherein the second leg end is movably fastened to the rear wall. The at least one table leg supports the tabletop in the function position at the rear wall. For that purpose, the first leg end is fastened to the underside of the tabletop and the second leg end is fastened to the rear wall. The fastening is movable in each case. The first leg end is fastened movably relative to the tabletop on the underside thereof. The second leg end is fastened movably relative to the rear wall on the latter. In one development, the second leg end is releasably fastened to the rear wall, wherein the fastening of the second leg end may be released to allow movement of the tabletop from the function position into the rest position.

In a further embodiment, the at least one table leg has a length extender which is extendable and retractable between different longitudinal positions, whereby a total length of the table leg is settable and hence also an inclination of the tabletop in the function position. The length extender is designed in different ways in different embodiments, for example as a telescopic mechanism, gas pressure cylinder, scissor-lift mechanism or the like. Preferably, the length extender is manually extendable and retractable. The table leg has a maximum total length in a completely extended state of the length extender. The table leg has a minimum total length in a completely retracted state of the length extender. The inclination of the tabletop can be set in the function position by a setting of the total length of the table leg. Improved ergonomics may be achieved by setting the inclination of the tabletop, for example when the table device is used as a workbench or as a writing desk.

In a further embodiment, the at least one table leg has a leg folding mechanism which allows the table leg to be both opened and collapsed, wherein the table leg is opened in the function position and collapsed in the rest position. The leg folding mechanism may be designed in any way suitable for the present purpose. Leg folding mechanisms for table legs are known for example from camping tables or other portable table devices. The leg folding mechanism may be used to collapse the table leg, allowing movement of the tabletop into the rest position in a functional and space-saving manner.

In a further embodiment, the table leg has a locking device by means of which the length extender and/or the leg folding mechanism are releasably lockable. The locking device may be designed in any way suitable for the present purpose, preferably as a ball catch mechanism. The locking device counteracts an unintended retraction of the length extender and hence also an unintended change in the inclination of the tabletop. Alternatively or additionally, the locking device counteracts any unintended collapsing of the table leg and hence also an unintended movement of the tabletop from the function position into the rest position.

In a further embodiment, the table device has two table legs, preferably exactly two, which are at a distance from one another along the transverse axis. As a result, improved support for the tabletop in the function position can be achieved. Preferably, the table legs are designed and/or arranged mirror-symmetrically in relation to a central longitudinal plane of the table device extending along the longitudinal axis and the vertical axis. Each table leg may have a length extender, a leg folding mechanism and/or a locking device in accordance with the preceding embodiments.

In a further embodiment, the tabletop has an extending mechanism, by means of which the tabletop is extendable in the function position to provide an enlarged surface area. As a result, the tabletop, or more precisely its surface area, may be enlarged as required. This results in a further improvement to the versatility of the storage space arrangement. In one embodiment, the extending mechanism permits an enlargement of the tabletop along the longitudinal axis. In a further embodiment, the extending mechanism permits, alternatively or additionally, an enlargement of the tabletop along the transverse axis. The extending mechanism may be designed in any way suitable for the present purpose. Extending mechanisms for tabletops are known from furniture making, for example.

In a further embodiment, the tabletop has a folding mechanism by means of which the tabletop may be folded out to obtain an enlarged surface area in the function position. The folding mechanism may be provided alternatively or additionally to the extending mechanism according to the preceding development. Folding mechanisms for the enlargement of tabletops are known from furniture making, for example. In comparison with extending mechanisms, folding mechanisms have as a rule a simpler design. In one embodiment, the folding mechanism permits folding out of the tabletop about at least one folding axis extending along the transverse axis. In a further embodiment, the folding mechanism permits, alternatively or additionally, folding out of the tabletop about a folding axis extending along the longitudinal axis. It is evident that the folding mechanism may have more than one folding axis.

In a further embodiment, the tabletop has at least one fastening receptacle which is recessed into the tabletop and configured to receive a fastening element. Due to the at least one fastening receptacle, items such as a shopping bag or other loads may be fastened to the tabletop in the rest position thereof. The fastening receptacle may be designed as a slot, hole or the like. The at least one fastening element is configured for releasable reception in the fastening receptacle and may be for example a peg, a hook or the like.

In a further embodiment, the rear wall is substantially completely covered by the flat-contacting tabletop in the rest position. This results in a particularly advantageous utilization of the available storage space in the rest position. In this development, a width of the tabletop extending along the transverse axis corresponds approximately to a width of the rear wall. A depth of the tabletop corresponds approximately to a height of the rear wall extending along the vertical axis.

In a further embodiment, the storage space is a front trunk (known as a frunk). Electric vehicles often have (one of) their trunks at the front. With the storage space arrangement in accordance with the invention, the frunk can be used in a particularly versatile and ergonomic way.

In a further embodiment, a front wall opposite the rear wall along a longitudinal axis is not present, so that the storage space is accessible at the front even in the function position of the tabletop. In this embodiment, the frunk is not enclosed all round by limiting walls, but is freely accessible towards the front when a front trunk lid of the motor vehicle is opened. The frunk accordingly has a lowered front loading edge, which is offset downwards from the tabletop along the vertical axis in the function position. This allows the frunk to be loaded and unloaded even in the function position of the tabletop.

In a further embodiment, the storage space floor, the at least two side walls and the rear wall are designed combined in one piece as a molded plastic part. Such a design as a molded plastic part permits a particularly simple manufacture and assembly of the storage space arrangement.

The invention additionally relates to a motor vehicle having a storage space arrangement according to the preceding description. Preferably, the motor vehicle is an electric vehicle.

The invention also relates to a table device for a motor vehicle and/or for a storage space arrangement according to the preceding description in each case. The table device in accordance with the invention has a tabletop. The tabletop is configured to be fastened to a rear wall of the storage space arrangement and to be movable relative to the rear wall between a function position and a rest position. In the rest position, the tabletop is moved vertically aligned to the rear wall. In the function position, the tabletop is moved horizontally aligned away from the rear wall. Developments of the table devices in accordance with the invention result from the features of the table device in the developments of the storage space arrangement in accordance with the invention.

Further advantages and features of the invention can be found in the claims and in the following description of a preferred example of the invention that are explained on the basis of the drawings.

The drawings show in:

FIG. 1 a schematic perspective view of an embodiment of a storage space arrangement in accordance with the invention with a table device whose tabletop is in a function position,

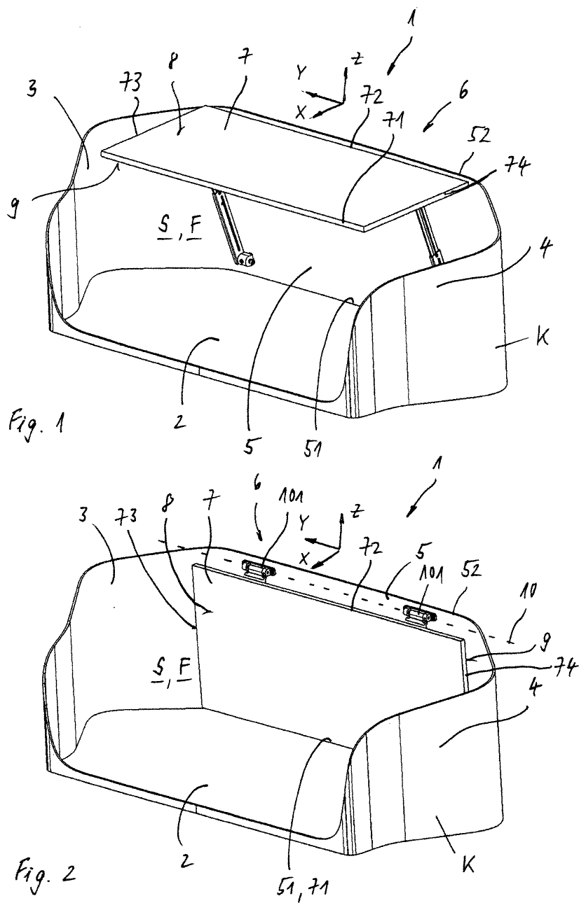

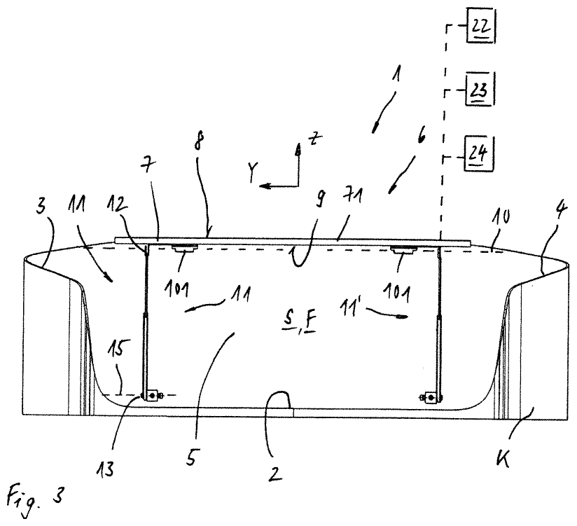

FIG. 2 a further schematic perspective view of the storage space arrangement according to FIG. 1, wherein the tabletop is in a rest position,

FIG. 3 the storage space arrangement according to FIGS. 1 and 2 in a schematic front view, wherein the tabletop is in the function position,

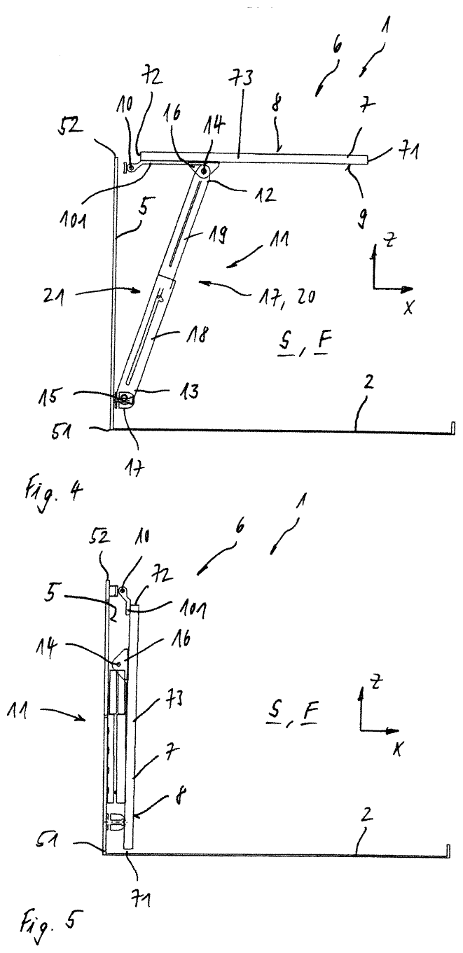

FIGS. 4, 5 partially cutaway and schematic side views of the storage space arrangement according to FIGS. 1 to 3 with the tabletop in the function position (FIG. 4) and in the rest position (FIG. 5),

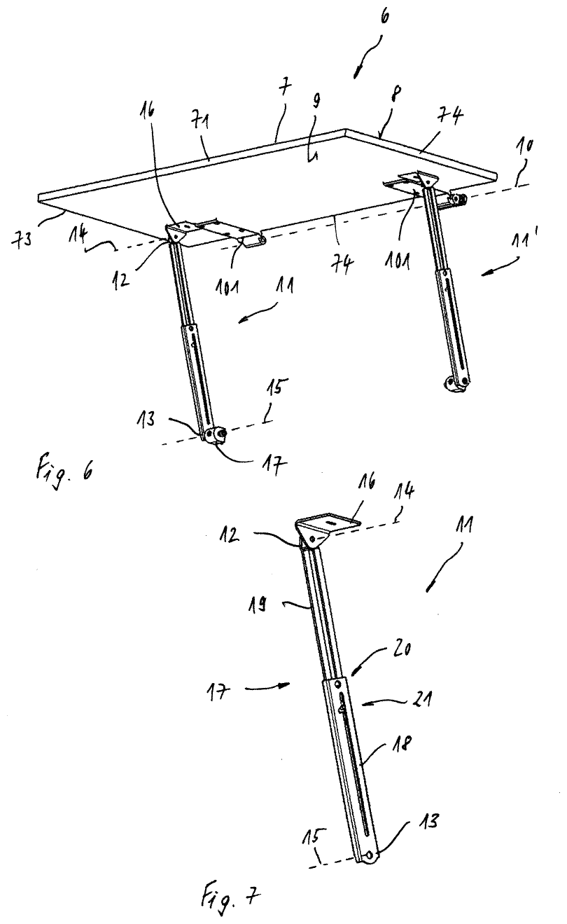

FIG. 6 a schematic perspective view of the table device of the storage space arrangement according to FIGS. 1 to 5 in a viewing direction obliquely upwards onto an underside of the tabletop and

FIG. 7 a schematic perspective view of a table leg of the table device according to FIG. 6.

According to FIGS. 1 to 5, a storage space arrangement 1 is provided for a motor vehicle and has a storage space floor 2, two side walls 3, 4, a rear wall 5 and a table device 6.

The storage space floor 2 limits a storage space S downwards along a vertical axis Z. In the embodiment shown, the storage space floor 2 is oriented flat and parallel to a horizontal plane extending along a transverse axis Y and a longitudinal axis.

The side walls 3, 4 each project upwards from the storage space floor 2 along the vertical axis Z and are opposite one another along the transverse axis Y. The side walls 3, 4 may also be referred to as the right-hand side wall 3 and the left-hand side wall 4. The two side walls 3, 4 each limit the storage space S sidewards. In the embodiment shown, the walls each project from the storage space floor 2 parallel to the vertical axis Z. The two side walls 3, 4 each have a curved course along the longitudinal axis X, which must be understood purely as an example.

The rear wall 5 projects from the storage space floor 2 along the vertical axis Z and extends along the transverse axis Y between the right-hand side wall 3 and the left-hand side wall 4. The rear wall 5 limits the storage space S rearwards along the longitudinal axis X. In the embodiment shown, the rear wall 5 projects from the storage space floor 2 parallel to the vertical axis Z. Also, the rear wall 5 in the present case extends between the two side walls 3, 4 parallel to the transverse axis Y.

In an embodiment not shown in the figures, the storage space arrangement has a front wall which is opposite the rear wall along the longitudinal axis X, projects from the storage space floor along the vertical axis Z and extends along the transverse axis Y between the two side walls. In the embodiment shown, no such front wall is present.

The storage space S is in the present case a front trunk F of a motor vehicle, otherwise not shown in detail, specifically designed as an electric vehicle. The front trunk F may also be referred to as a frunk. The frunk F is openably closed in a manner known to a person skilled in the art with a front trunk lid of the motor vehicle. In the opened state of the front trunk lid, the frunk F is accessible for loading and unloading.

Since the storage space arrangement 1 does not have a front wall in the embodiment shown, the frunk F is freely accessible from the front in the opened state of the front trunk lid along the longitudinal axis X.

The table device 6 has a tabletop 7 which is movable between a function position and a rest position. In FIGS. 1, 3 and 4, the tabletop 7 is in the function position. In FIGS. 2 and 5, the tabletop 7 is in the rest position.

The tabletop 7 is fastened to the rear wall 5 movable relative to the rear wall 5 between the function position and the rest position.

In the function position, the tabletop 7 is horizontally aligned and moved away from the rear wall 5. In the rest position, the tabletop 7 is vertically aligned and moved to the rear wall 5.

In the embodiment shown, the tabletop 7 is parallel to the transverse axis Y and to the longitudinal axis X in the function position and hence extends parallel to a horizontal plane. This is the case in the figures shown. However, the orientation of the tabletop 7, specifically its inclination in relation to the longitudinal axis X, is settable in a manner described in more detail below.

In the rest position, the tabletop 7 is in the present case aligned parallel to a vertical transverse plane, i.e. extending parallel to the transverse axis Y and to the vertical axis Z.

The tabletop 7 has an upper side 8 and an underside 9, which are opposite one another in the thickness direction of the tabletop 7. The upper side 8 forms the actual table surface of the tabletop.

In the function position, the upper side 8 Faces vertically upwards and the underside 9 vertically downwards. In the rest position, the upper side 8 along the longitudinal axis X faces forwards and the underside 9 rearwards.

In the embodiment shown, the tabletop 7 is aligned parallel to the storage space floor 2 in the function position. The tabletop 7 is arranged above the storage space floor 2 in the function position. In the rest position, the tabletop 7 is aligned parallel to the rear wall 5.

The rear wall 5 extends along the vertical axis Z between a bottom edge 51 and a top edge 52. In the function position, the tabletop 7 extends at the level of the top edge 52.

In the embodiment shown, the tabletop 7 has a rectangular basic shape with a front edge 71, a rear edge 72, a right-hand outer edge 73 and a left-hand outer edge 74.

The right-hand outer edge 73 faces the right-hand side wall 3. The left-hand outer edge 74 faces the left-hand side wall 4. The right-hand outer edge 73 and the left-hand outer edge 74 are opposite one another along the transverse axis Y. The front edge 71 and the rear edge 72 are opposite one another in the depth direction of the tabletop 7. The front edge 71 here faces forwards along the longitudinal axis X in the function position and downwards along the vertical axis Z in the rest position. The rear edge 72 faces rearwards along the longitudinal axis X in the function position and upwards along the vertical axis Z in the rest position.

The tabletop is, in different embodiments, movable in different ways between the rest position and the function position.

In the embodiment shown, the tabletop 7 is swingably movable about a swing axis 10. The swing axis 10 is in the present case an axis in the geometrical sense.

The swing axis 10 extends, in the embodiment shown, longitudinally parallel to the transverse axis Y and is arranged along the vertical axis Z at the level of the upper edge 52 of the rear wall 5. Accordingly, the swing axis 10 is arranged in the area of the rear edge 72 of the tabletop 7.

The swing axis 10 is formed in the present case by two hinge elements 101. The hinge elements 101 are at a distance from one another along the transverse axis Y and each fastened both to the rear wall 5 and to the tabletop 7, specifically to its underside 9. It is evident that the swing axis 10 may also be designed in a different manner, for example by a so-called piano hinge, a swing mechanism or the like.

The table device 6 has at least one table leg 11, 11′, wherein two table legs, which may also be referred to as the right-hand table leg 11 and the left-hand table leg 11′, are provided in the embodiment shown. The two table legs 11, 11′are substantially identical in respect of their function and design. To avoid repetition, the further features of the table legs 11, 11′are therefore explained in the following principally with reference to the right-hand table leg 11. The statements regarding the right-hand table leg 11 apply mutatis mutandis for the left-hand table leg 11′too.

The table leg 11 extends longitudinally between a first leg end 12 and a second leg end 13. The first leg end 12 is movably fastened to the tabletop 7, specifically to the underside 9. The second leg end 13 is movably fastened to the rear wall 5.

In the embodiment shown, the first leg end 12 is fastened to the tabletop 7 swivelably movable about a first swivel axis 14. The swivel axis 14 is formed at an upper fitting 16 which is fastened to the underside 9.

The second leg end 13 is connected to the rear wall 5 swivelably movable about a second swivel axis 15. The second swivel axis 15 is in the present case formed at a lower fitting 17 which is fastened to the rear wall 5.

The first swivel axis 14 is arranged in the present case at the level of the swing axis 10 in relation to the vertical axis Z. The second swivel axis 15 is arranged in the present case in the area of the lower edge 51 of the rear wall 5 in relation to the vertical axis Z.

The first swivel axis 14 and the second swivel axis 15 each extend longitudinally parallel to the swing axis 10 and hence also to the transverse axis Y.

In the function position, the tabletop 7 is supported at the rear wall 5 by means of the table legs 11, 11′downwards along the vertical axis Z. In the rest position, the table legs 11, 11′are arranged along the longitudinal axis X between the rear wall 5 and the underside 9 of the tabletop 7, and concealed by means of the tabletop 7 in the direction of the storage space S.

In the embodiment shown, the table leg 11 has a length extender 17. The length extender 17 is extendable and retractable between different longitudinal positions. As a result, a total length of the table leg 11 and hence also an inclination of the tabletop 6 is settable in relation to the longitudinal axis X. If the table legs 11, 11′are shortened relative to the function position shown in the present case by means of the length extenders 17, the tabletop 7 inclines downwards in the area of its front edge 71. This allows improved ergonomics to be achieved, for example when the tabletop 7 is used as a work surface or writing surface.

In the embodiment shown, the length extender 17 is a telescopic mechanism which provides a two-part design of the table leg 11 with a shaft part 18 and an extending part 19. The extending part 19 is insertable into the shaft part 18 and extractable therefrom along the longitudinal direction of the table leg 11. This design of the length extender 17 with the two-part design of the table leg 11 must be understood as an example. In embodiments not shown in the figures, the length extender is for that purpose of differing design, for example in the form of a gas pressure spring, a scissor-lift mechanism or the like.

In the embodiment shown, the table leg 11 also has a leg folding mechanism 20, allowing the table leg 11 to be opened and collapsed. In the function position, the table leg 11 is opened by means of the leg folding mechanism 20. In the rest position, the table leg 11 is collapsed by means of the leg folding mechanism 20 (see in particular FIG. 5). In the collapsed state, the shaft part 18 and the extending part 19 are in flat contact with one another.

In the embodiment shown, the table leg 11 also has a locking device 21 by means of which the length extender 17 and/or the leg folding mechanism 20 are releasably lockable. The locking device 21 may be operated manually to release the lock. In the embodiment shown, the locking device 21 is designed such that the length extender 17 and the leg folding mechanism 20 are automatically locked upon reaching the function position. To permit movement of the tabletop 7 into the rest position, the locking device 21 must be manually operated to release the lock. The locking device 21 is designed as a ball catch mechanism in the embodiment shown. The ball catch mechanism releases the lock as soon as the tabletop 7 is swiveled starting from the function position 7 further upwards about the swing axis 10. Once the lock has been released in this way, the tabletop 7 may be swiveled downwards about the swing axis 10 to move it into the rest position.

In the embodiment shown, the tabletop 7 also has an extending mechanism 22, a folding mechanism 23 and at least one fastening receptacle 24. The extending mechanism 22, the folding mechanism 23 and the fastening receptacle 24 are optional and not provided in all embodiments. The extending mechanism 22, the folding mechanism 23 and the fastening receptacle 24 are shown in FIG. 3 schematically and in simplified form as function blocks.

The extending mechanism 22 permits an enlargement of the table surface 8 as required. In other words, the tabletop 7 may be extended by means of the extending mechanism 22 along the longitudinal axis X and/or the transverse axis Y. The specific design of the extending mechanism 22 is not indicated in the figures. Extending mechanisms for enlargement of tabletops are however known from furniture making, for example. For that reason, it is not necessary to go into detail at this point.

The folding mechanism 23 may be provided alternatively or additionally to the extending mechanism 22. The folding mechanism 23 permits the tabletop 7 to be folded out and folded together as required in order to enlarge the table surface 8. In one development, the folding mechanism 23 has a folding axis extending longitudinally parallel to the front edge 71, about which parts of the tabletop are foldably movable relative to one another. Alternatively or additionally, the folding mechanism 23 may have a folding axis extending on the right-hand outer edge 73 and/or on the left-hand edge 74. The figures show no further details of the folding mechanism 23. However, folding mechanisms for the enlargement of tabletops are known from furniture making. For that reason, it is not necessary to go into detail at this point.

The at least one fastening receptacle 24 is configured for releasable reception of a fastening element. Preferably, the fastening receptacle 24 is recessed into the upper side 8, for example in the form of a hole, channel or undercut groove or the like. The tabletop 7 may have several fastening receptacles arranged distributed over the upper side 8, which may be of identical or different design. The fastening receptacle 24 permits the fastening of items to the tabletop, in particular when it is in the rest position. The complementary fastening element may be a hook, a peg or the like.

In the embodiment shown, the storage space floor 2, the two side walls 3, 4 and the rear wall 5 are designed combined in one piece as a molded plastic part K. The molded plastic part K is inserted and fitted during production of the said passenger car into a space intended for that purpose in the vehicle body.

1. A storage space arrangement for a motor vehicle, comprising:
a storage space floor limiting a storage space downwards along a vertical axis;
at least two side walls which each projecting upwards from the storage space floor along the vertical axis and being opposite one another along a transverse axis;
a rear wall projecting upwards from the storage space floor along the vertical axis and extending along the transverse axis between the side walls; and
a table device with a tabletop fastened to the rear wall and movable relative to the rear wall between a function position and a rest position;
wherein the tabletop is oriented in a vertical position aligned with the rear wall in the rest position,
and the tabletop is oriented in a horizontal position away from the rear wall in the function position.

2. The storage space arrangement according to claim 1, wherein the table device has a swing axis, the tabletop being swingably movable about the swing axis between the function position and the rest position.

3. The storage space arrangement according to claim 1, wherein the table device has at least one table leg extending longitudinally between a first leg end and a second leg end, the first leg end being movably fastened to an underside of the tabletop, and the second leg end being movably fastened to the rear wall.

4. The storage space arrangement according to claim 3, wherein the at least one table leg has a length extender, the leg extender being extendable and retractable between different longitudinal positions, whereby a total length of the table leg is settable to define an inclination of the tabletop in the function position.

5. The storage space arrangement according to claim 3, wherein the at least one table leg has a leg folding mechanism allowing the table leg to be opened and collapsed, the table leg being opened in the function position and collapsed in the rest position.

6. The storage space arrangement according to claim 4, wherein the at least one table leg has a locking device releasably locking the length extender.

7. The storage space arrangement according to claim 3, wherein the at least one table leg comprises two table legs disposed a distance from one another along the transverse axis.

8. The storage space arrangement according to claim 1, wherein the tabletop has an extending mechanism, the extending mechanism extending the tabletop in the function position to provide an enlarged surface area.

9. The storage space arrangement according to claim 1, wherein the tabletop has a folding mechanism, the folding mechanism folding out the tabletop to obtain an enlarged surface area in the function position.

10. The storage space arrangement according to claim 1, wherein the tabletop has at least one fastening receptacle, the at least one fastening receptacle being recessed into the tabletop and configured to receive a fastening element.

11. The storage space arrangement according to claim 1, wherein the rear wall is substantially completely covered by the tabletop in the rest position.

12. The storage space arrangement according to claim 1, wherein the storage space is a front trunk.

13. The storage space arrangement according to claim 12, wherein a front wall opposite the rear wall is not present, so that the storage space is accessible at a front in the function position of the tabletop.

14. The storage space arrangement according to claim 1, wherein the storage space floor, the at least two side walls and the rear wall are combined in one piece as a molded plastic part.

15. A motor vehicle, having a storage space arrangement according to claim 1.

16. A table device for a storage space arrangement including at least two side walls and a rear wall, the table device comprising a tabletop configured to be fastened to the rear wall of the storage space arrangement and to be movable relative to the rear wall between a function position and a rest position, wherein the tabletop is oriented in a vertical position aligned with the rear wall in the rest position, and the tabletop is oriented in a horizontal position away from the rear wall in the function position.

17. A table device for a motor vehicle having a storage space arrangement including at least two side walls and a rear wall, the table device comprising a tabletop configured to be fastened to the rear wall of the storage space arrangement and to be movable relative to the rear wall between a function position and a rest position, wherein the tabletop is oriented in a vertical position aligned with the rear wall in the rest position, and the tabletop is oriented in a horizontal position away from the rear wall in the function position.
